(19) United States
(12) Patent Application Publication
(10) Pub. No.: US 2007/0180508 A1
(43) Pub. Date: Aug. 2, 2007

(54) Shared authentication for composite applications

(75) Inventor: Brian Ward Thomson, Unionville (CA)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/342,774

(22) Filed: Jan. 30, 2006

(51) Int. Cl. G06F 17/30

(52) U.S. Cl. 726/8

(57) ABSTRACT

Embodiments of the present invention address deficiencies of the art in respect to SSO in an aggregated application and provide a method, system and computer program product for shared authentication for composite applications. In one embodiment of the invention, a method for shared authentication in a composite application can include masquerading application components for the composite application as login modules in a pluggable authentication module (PAM) framework, and performing an SSO for the PAM framework.

### BACKGROUND OF THE INVENTION

1. Field of the Invention

The present invention relates to the field of composite applications and more particularly to authentication within a composite application.

2. Description of the Related Art

Distributing content about large computer communications networks is not without its challenges. In particular, the quantity of content available for distribution in a computer communications network often varies proportionally to the size of the computer communications network. At the extreme, the Internet hosts a vast quantity of content not easily accessible by most end-users. Composite applications such as portals represent a sensible solution to the problem of aggregating content through a channel paradigm in a single, network-addressable location. In consequence, composite applications have become the rage in content distribution.

Application components like portlets are the visible active components included as part of the composite application. Similar to the graphical windows paradigm of windowing operating systems, each application component in a composite application occupies a portion of the visible page through which the application component can display associated content from a component channel. Application components like portlets are known to include both simple applications such as an electronic mail client, and also more complex applications such as forecasting output from a customer relationship management system. The prototypical application component can be implemented as a server-side script executed through a composite application server.

From the end-user perspective, an application component is a content channel or application to which the end-user can subscribe. By comparison, from the perspective of the content provider, a application component is a means through which content can be distributed in a personalized manner to a subscribing end-user. Finally, from the point of view of the composite application, an application component merely is a component which can be rendered within the composite application. In any case, by providing one or more individually selectable and configurable application components in a composite application, composite application providers can distribute content and applications through a unified interface in a personalized manner according to the preferences of the end-user.

Despite the inclusion of each application component in a single, aggregated environment, each application component can require the creation of a separate session as between the application component and an interacting user. Specifically, the session can be used to facilitate access control to the data for the application component. To avoid the clumsiness of multiple authentication processes for each application component in an component aggregation environment, a single sign-on (SSO) authentication process can be included in the component aggregation environment. In an SSO authentication process, an interacting user can provide authentication data once and the SSO authentication process can provide the authentication data to each dependent application component.

SSO authentication for a composite application subsists in several different forms. In a mandated common authentication form, application components are required to use a common authentication service that delivers an authentication token. The token subsequently can be used to access all applications in the aggregation. As it will be recognized, however, a mandated common authentication form requires a high degree of integration between application components to ensure compatibility in processing token. Consequently, mandated common authentication cannot be viably deployed for ad hoc aggregations of disparate application components.

To address the aggregation of disparate application components, SSO has been emulated in a synchronized authentication solution. In a synchronized authentication solution, multiple authentication domains exist for respective application components. An administrative structure for the aggregation, however, can enforce uniformity among credentials in that a user name and password must be identical for each application component. The administrative structure in turn can collect credentials and supply those credentials to the different application components in an aggregation in order to simulate SSO. It is to be understood, however, that to implement synchronized authentication requires the reconciliation of different credentialing protocols including user name and password length and content limitations for each application component.

Finally, as yet a third variation on SSO, a SSO credential can be used to open a vault of credentials for different application components. The credentials for the different application components can be applied as necessary to the different applications while requiring the end user only to provide the single credential to unlock the vault.

In all cases, however, SSO has not been implemented for an aggregated application in a uniform manner without requiring a high degree of integration among the different components of the aggregation, or the creation of an additional purpose-built application component to layer over the preexisting application components and mediate and coordinate their authentication activities.

### BRIEF SUMMARY OF THE INVENTION

Embodiments of the present invention address deficiencies of the art in respect to SSO in an aggregated application and provide a novel and non-obvious method, system and computer program product for shared authentication for composite applications. In one embodiment of the invention, a method for shared authentication in a composite application can include masquerading application components for the composite application as login modules in a pluggable authentication module (PAM) framework, and performing an SSO for the PAM framework.

In one aspect of the embodiment, masquerading application components for the composite application as login modules in a PAM framework, can include registering the application components as a low-priority login module in the PAM framework. In another aspect of the invention, masquerading application components for the composite application as login modules in a PAM framework can include loading an aggregation environment for managing the composite application, contributing an extension to the aggregation environment for each of the application components, and providing a login module as part of each extension.

Performing an SSO for the PAM framework can include loading an authentication driver in the PAM framework and performing the SSO through the authentication driver. Optionally, performing the SSO through the authentication driver, can include performing the SSO through the authentication driver responsive to detecting a trigger. In either case, performing the SSO through the authentication driver can include creating a login context and invoking a login method for the login context.

In this regard, invoking a login method for the login context can include obtaining credentials for the SSO, identifying each of the login modules for the application components, and providing the credentials to each of the login modules. Also, identifying each of the login modules for the application components can include first identifying high-priority login modules for performing an authentication for the SSO, and second identifying low-priority login modules corresponding to the application components.

In another embodiment of the invention, a shared authentication data processing system for composite applications can include an aggregation environment configured to host composite applications formed from an aggregation of application components, and a PAM framework coupled to the aggregation environment. The PAM framework can include a login context coupled to a configuration and enabled to pass credentials to each of a plurality of login modules. Moreover, each login module can act as a masquerade for a corresponding application component in a composite application.

In one aspect of the invention, the PAM framework can be a Java Authentication and Authorization Service (JAAS) implementation of a PAM framework. In another aspect of the embodiment, the login modules can be low-priority login modules. Finally, each of the login modules can be disposed in an extension point for the corresponding application component.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a host environment configured for providing shared authentication for hosted composite applications; and,

FIG. 2 is a flow chart illustrating a process for shared authentication among application components in a composite application.

### DETAILED DESCRIPTION OF THE INVENTION

Embodiments of the present invention provide a method, system and computer program product for shared authentication for composite applications. In accordance with an embodiment of the present invention, application components of a composite application can masquerade as pluggable login modules for an authentication and authorization service in an aggregation environment. In consequence, when credentials are obtained through the invocation of login logic in the authentication and authorization service, the credentials automatically can be provided to the application components masquerading as pluggable login modules. As a result, SSO can be achieved for a composite application without requiring a high degree of integration among the application components of the composite application.

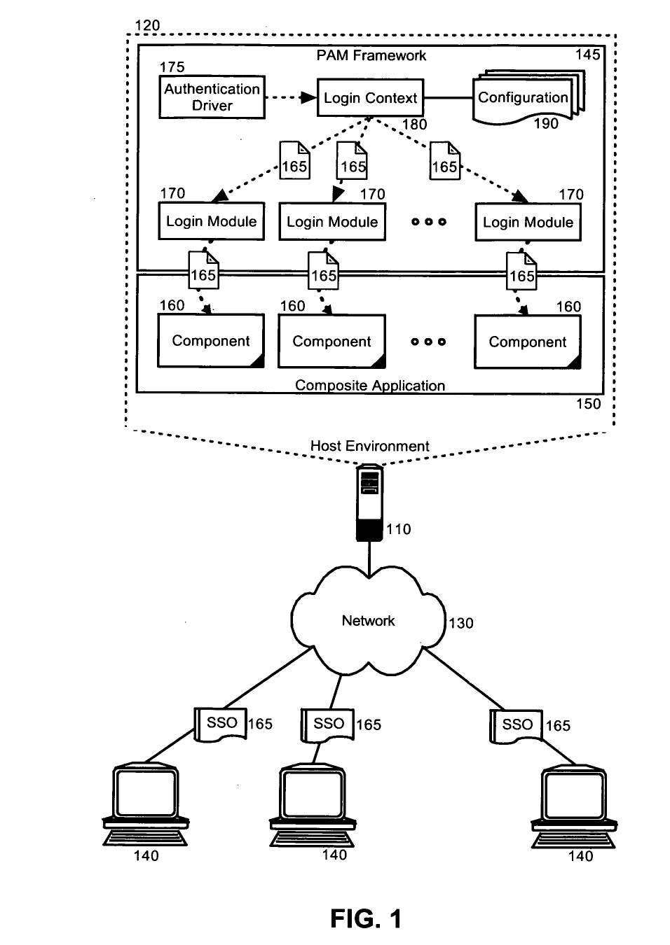

In more particular illustration, FIG. 1 is a schematic illustration of a host environment configured for providing shared authentication for hosted composite applications. As shown in FIG. 1, an aggregation environment 120 can be provided within a host computing platform 110. The aggregation environment 120 can include a configuration for aggregating different application components 160 into a composite application 150. The host computing platform 110 further can include a configuration for delivering access to communicatively coupled clients 140 over a computer communications network_{[SMG3]} 130. Notably, the aggregation environment 120 can provide a SSO experience for communicatively clients 140 seeking to access individual ones of the application components 160 in the composite application 150.

To provide the SSO experience, the aggregation environment 120 can include a PAM framework 145. The PAM framework 145 can be a modularized architecture known in the art to support the seamless exchange of one security protocol component for another. As such, the PAM framework 145 can allow multiple authentication technologies and authentication approaches to be added without changing or interfering with any existing login services for a client application. The PAM framework 145 yet further can integrate with a multiplicity of different login services for different authentication technologies, including Rivest-Shamir-Adelman (RSA), data encryption standard (DCE), Kerberos, challenge/response authentication (S/Key) and smartcard based systems, to name a few. Notably, the PAM framework 145 can be a JAAS implementation.

Importantly, the PAM framework 145 can permit the registration of each of the application components 160 in the composite application 150 as a low-priority login module 170. In the course of registration, the identity of the low-priority login module 170 can be recorded in a configuration 190. An authentication driver 175 further can be provided_{[SMG4]} at part of the aggregation environment 120. The authentication driver 175 can include program code enabled to respond to an invocation trigger by creating a login context 180 and invoking a login process within the login context 180. The login process of the login context 180 can produce credentials 165 for different clients 140 engaging in SSO as requested by a user interface provided by the authentication driver 175. As part of the login process for the login context 180, the credentials 165 can be passed to the low-priority login modules 170 specified in the configuration 190. In this way, the application components 160, masquerading as login modules 170 plugged into the PAM framework 145, can receive the credentials 165 generated by the SSO operation.

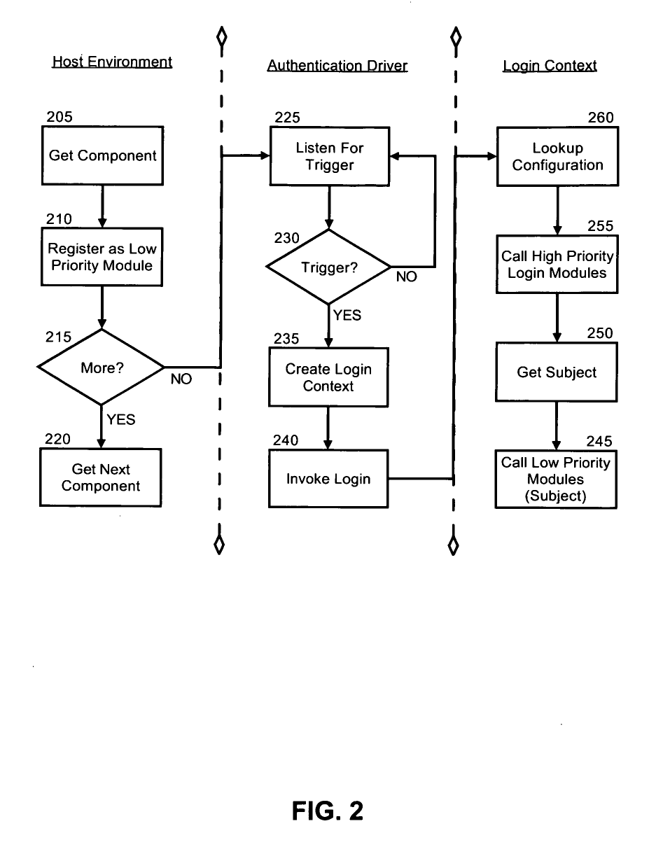

As an additional illustration, FIG. 2 is a flow chart illustrating a process for shared authentication among application components in a composite application. Beginning first within the host environment, in block 205 an application component can be selected for shared authentication. In block 210, the selected application component can be registered as a low priority module in the PAM framework. In decision block 215, if additional applications are to be registered in the PAM framework, a new application component can be selected in block 220 and the process can repeat through block 210. When no further application components are to be registered in the PAM framework, the process can continue with the authentication driver in block 225.

In block 225, the authentication driver can listen for a trigger. The trigger can include, by way of example, the launching of the environment, the swiping of a smartcard or the detection of one or more keyboard strokes recognized as a “hotkey”. In decision block 230, if a trigger is detected, in block 235 a login context in the PAM framework can be created. The login context can include a class providing authentication methods for authenticating subjects in the PAM framework. The subject, as it is well-known in the art, can represent the source of a request to access resources which request is satisfied through authentication. As such, the login method for the login context can be invoked in block 240 and, upon invocation, the process can continue within the login context.

In block 260, the configuration can be identified for the login request and in block 255, the high-priority login modules implicated by the configuration can be retrieved and executed in a two-phase commit process in order to obtain credentials in performing the authentication. A subject can be returned in block 250 subsequent to the first phase. Thereafter, in the second phase of the two-phase commit process, in block 245 the low priority modules implicated by the configuration and which masquerade for the registered application components can be called along with the subject provided by the first phase of the two-phase commit process.

In this way, all of the registered application components can receive the credentials for the login process while requiring the end user to engage only in a SSO process. Yet, no high level of integration between application components will be required. Rather, each application component need only register with the PAM framework, for instance by contributing an extension point to the aggregation environment and by providing a corresponding the login module. Accordingly, each application component can share authentication for the composite application.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for shared authentication in a composite application, the method comprising:
masquerading application components for the composite application as login modules in a pluggable authentication module (PAM) framework; and,
performing a single sign on (SSO) for the PAM framework.

2. The method of claim 1, wherein masquerading application components for the composite application as login modules in a PAM framework, comprises registering the application components as a low-priority login module in the PAM framework.

3. The method of claim 1, wherein masquerading application components for the composite application as login modules in a PAM framework, comprises:
loading an aggregation environment for managing the composite application;
contributing an extension to the aggregation environment for each of the application components; and,
providing a login module as part of each extension.

4. The method of claim 1, wherein performing an SSO for the PAM framework, comprises:
loading an authentication driver in the PAM framework; and,
performing the SSO through the authentication driver.

5. The method of claim 1, wherein performing the SSO through the authentication driver, comprises performing the SSO through the authentication driver responsive to detecting a trigger.

6. The method of claim 1, wherein performing the SSO through the authentication driver comprises:
creating a login context; and,
invoking a login method for the login context.

7. The method of claim 6, wherein invoking a login method for the login context, comprises:
identifying each of the login modules for the application components;
creating a subject to represent an identity being authenticated; and
invoking the login modules with the created subject_{[SMG6]}.

8. The method of claim 7, wherein identifying each of the login modules for the application components, comprises:
first identifying high-priority login modules for performing an authentication for the SSO; and,
second identifying low-priority login modules corresponding to the application components.

9. An shared authentication data processing system for composite applications, the data processing system comprising:
an aggregation environment configured to host composite applications formed from an aggregation of application components; and,
a pluggable authentication module (PAM) framework coupled to the aggregation environment, the PAM framework comprising a login context coupled to a configuration and enabled to pass credentials to each of a plurality of login modules, each login module acting as a masquerade for a corresponding application component in a composite application.

10. The system of claim 9, wherein the PAM framework is a Java Authentication and Authorization Service (JAAS) implementation of a PAM framework.

11. The system of claim 9, wherein the login modules are low-priority login modules_{[SMG8]}.

12. The system of claim 9, wherein each of the login modules are disposed in an extension point for the corresponding application component.

13. A computer program product comprising a computer usable medium having computer usable program code for shared authentication in a composite application, the computer program product including:
computer usable program code for masquerading application components for the composite application as login modules in a pluggable authentication module (PAM) framework; and,
computer usable program code for performing a single sign on (SSO) for the PAM framework.

14. The computer program product of claim 13, wherein the computer usable program code for masquerading application components for the composite application as login modules in a PAM framework, comprises computer usable program code for registering the application components as a low-priority login module in the PAM framework.

15. The computer program product of claim 13, wherein the computer usable program code for masquerading application components for the composite application as login modules in a PAM framework, comprises:
computer usable program code for loading an aggregation environment for managing the composite application;
computer usable program code for contributing an extension to the aggregation environment for each of the application components; and,
computer usable program code for providing a login module as part of each extension.

16. The computer program product of claim 13, wherein the computer usable program code for performing an SSO for the PAM framework, comprises:
computer usable program code for loading an authentication driver in the PAM framework; and,
computer usable program code for performing the SSO through the authentication driver.

17. The computer program product of claim 13, wherein the computer usable program code for performing the SSO through the authentication driver, comprises computer usable program code for performing the SSO through the authentication driver responsive to detecting a trigger.

18. The computer program product of claim 13, wherein the computer usable program code for performing the SSO through the authentication driver comprises:
computer usable program code for creating a login context; and,
computer usable program code for invoking a login method for the login context.

19. The computer program product of claim 18, wherein the computer usable program code for invoking a login method for the login context, comprises:
computer usable program code for identifying each of the login modules for the application components;
computer usable program code for creating a subject to represent an identity being authenticated; and
computer usable program code for invoking the login modules with the created subject.

20. The computer program product of claim 19, wherein the computer usable program code for identifying each of the login modules for the application components, comprises:
computer usable program code for first identifying high-priority login modules for performing an authentication for the SSO; and,
computer usable program code for second identifying low-priority login modules corresponding to the application components.
